(19) United States
(12) Patent Application Publication
(10) Pub. No.: US 2025/0211323 A1
(43) Pub. Date: Jun. 26, 2025

(54) INTERFERENCE DETECTION IN A COMMUNICATIONS NETWORK

(71) Applicant: Hughes Network Systems, LLC, Germantown, MD (US)

(72) Inventors: David Whitefield, Germantown, MD (US); Soham Sheth, Germantown, MD (US); Aryan Marwah, Germantown, MD (US); Mohamed Aamir, Germantown, MD (US)

(21) Appl. No.: 18/395,898

(22) Filed: Dec. 26, 2023

(51) Int. Cl. H04B 7/185

(52) U.S. Cl. CPC H04B 7/18519

(57) ABSTRACT

A processor can be configured to execute instructions stored in a memory to obtain a sample of a first received signal and to extract a suspected interference characteristic from the sample. The instructions can additionally be to generate a parameter for input to a machine learning application based on the extracted suspected interference characteristic, the input parameter including a weight or a setting and to transmit a first request to a transmitter of the first received signal to modify a parameter of the transmitter responsive to the input parameter.

### BACKGROUND

In a communications network that utilizes wireless radio frequency (RF) communication channels between transmitting and receiving stations, an interfering signal can degrade the quality of a signal transmitted from a transmitting station and received at a receiving station. Such degradations in signal quality can result in a loss of data in a received signal, an increase in the bit error rate of a received signal, etc.

### BRIEF DESCRIPTION OF THE DRAWINGS

FIG. 1 is a diagram of an example network that utilizes a satellite to communicate with a client ground station.

FIG. 2 shows a profile of a received RF signal combined with an interfering signal received at a client ground station.

FIG. 3 is a diagram showing a client ground station communicating with a second processor to detect interference in a communications network.

FIG. 4 is a flowchart for a process for interference detection and mitigation in a communications network.

### DETAILED DESCRIPTION

In a wireless communications system, a transmitting station can transmit a signal for receipt at a receiving station. A transmitting station may utilize a modulator and an RF amplifier coupled to a suitable antenna, so as to provide a transmitted signal that is capable of overcoming noise and interfering signals that may be received by the receiving station. A transmitting station may additionally utilize an error control code that permits the receiving station to decode transmitted information that may have been lost due to brief (e.g., less than one second) degradations in the quality of a wireless communications channel. A receiving station may additionally utilize an antenna that provides positive signal gain in certain directions while providing negative signal gain in other directions.

In some instances, in response to a receiving station detecting a degradation in signal quality, a transmitting station may be requested to modify a transmission parameter, such as a modulation coding scheme, which may permit the degraded signal to be received and decoded despite the presence of an interfering signal. For example, a transmitting station may be requested to switch a modulation coding scheme from a 16-state quadrature amplitude modulation (QAM) technique, in which a carrier signal is modulated into any of 16 different phase and amplitude states, to a two-state binary phase-shift keying (BPSK) technique, in which a carrier signal is modulated into one of two carrier phase states. In response to adjustment of a modulation coding scheme and/or an error control coding scheme, a transmitting station may be capable of compensating for certain types of interference in a communications channel between the transmitting and the receiving station.

However, in some instances, an interfering noise signal may degrade a communications channel in a manner that cannot be compensated for by an error control coding technique or by adjustment of a modulation coding scheme. Accordingly, information transmitted by a transmitting station may be unrecoverable at a receiving station. In one example, in a satellite communication system that utilizes a first satellite operating in a geosynchronous orbit to transmit signals to a receiving ground station, a second satellite orbiting in an adjacent orbital slot (e.g., another satellite in a geosynchronous orbit (GEO)) or a second satellite orbiting beneath the geosynchronous satellite (e.g., a satellite traveling in a low Earth orbit (LEO), may generate significant in-band signal interference over an extended duration (e.g., 30 seconds, one minute, two minutes, etc.). Under such circumstances, a receiving ground station may be unable to receive transmissions from the geosynchronous satellite, thereby losing data transmitted from the geosynchronous satellite. In such instances, after the interfering LEO satellite has passed, the receiving ground station and the geosynchronous satellite may undergo a resynchronization process, which may delay reception of transmissions from the geosynchronous satellite until the resynchronization process has completed.

In accordance with examples described herein, a receiving or “client” ground station (e.g., having a first processor) can be requested by a server (e.g., having a second processor) to sample an incoming signal over a received RF spectrum. In an example, a client ground station can be requested by a server to perform on-demand sampling of a received signal spectrum and/or can be configured by a server to perform recurrent sampling of a received signal spectrum. In this context, a “client” means a computing entity that operates under the direction of a server to perform sampling and/or analysis functions with respect to a signal received over a spectrum of radio frequencies. In an example, in addition to sampling an incoming signal over a received RF spectrum, a client ground station can execute program instructions to determine whether the incoming signal exhibits suspected interference. In an example, the client ground station can determine whether such suspected interference is present in a received RF signal by executing program instructions to compute a linear approximation of the power of a received signal over the received RF spectrum. In an example, the client ground station can additionally execute program instructions to compute a curve fit over at least a portion of the received signal spectrum and to compute properties of the curve fit with respect to the computed linear approximation. Such properties can include whether a portion of the curve fit deviates (e.g., exceeds) a threshold power with respect to the linear approximation of the power over the received signal spectrum, the slope at a point on the curve fit, etc. In an example, after executing program instructions to analyze a curve fit and a linear approximation of a received signal spectrum as inputs, a client ground station can store a profile of the sampled incoming signal in a memory based on the received signal spectrum deviating from a threshold power, which may indicate a presence of suspected interference.

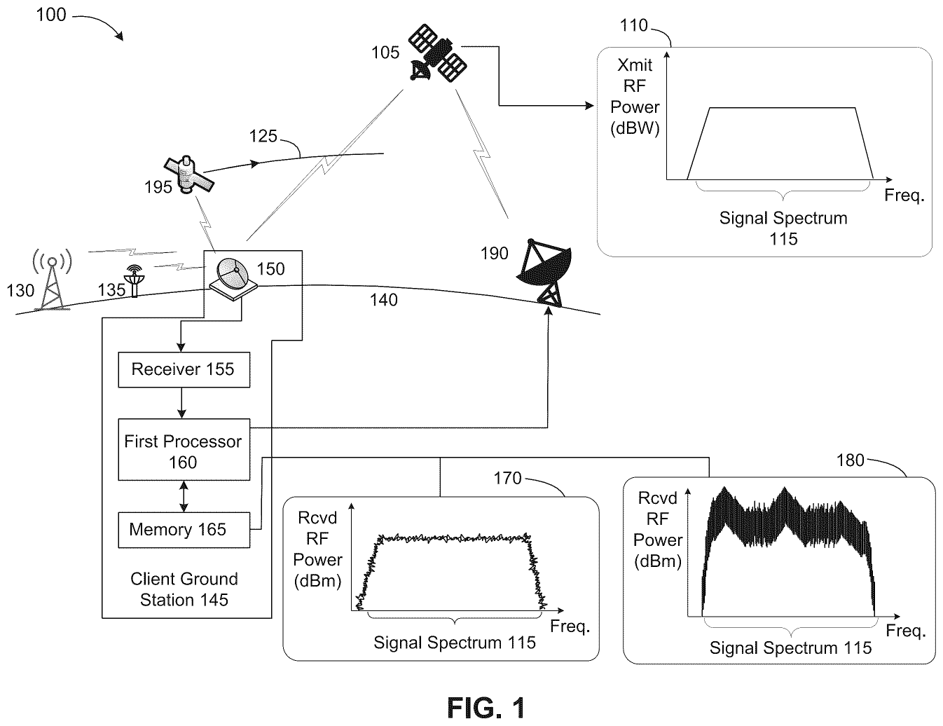

In this context, an “RF spectrum,” an “RF signal spectrum,” or simply a “spectrum” means a range of radio frequencies utilized to communicate all or a portion of a modulated signal between a transmitter and a receiving station. Thus, in an example, a satellite (e.g., satellite 105 of FIG. 1) may utilize an RF spectrum to communicate a modulated signal, utilizing any suitable modulation technique, from the satellite to a ground station (e.g., client ground station 145). In an example, an RF spectrum can refer to a range of frequencies utilized to communicate an information-bearing signal, such as an RF spectrum of 100 megahertz to communicate a signal that consumes a bandwidth of, for example, 100 megahertz. In another example, an RF spectrum can refer to a range of frequencies utilized to communicate a portion of an information-bearing signal, such as an RF spectrum of 10 megahertz, 20 megahertz, 25 megahertz, 50 megahertz, etc., utilized to communicate a signal that consumes a combined bandwidth of, for example, 100 megahertz.

In an example, on a recurring configured schedule, such as on a daily basis or in response to receipt of a query from a server (e.g., having a second processor), a client ground station (e.g., having a first processor) can transmit a stored profile of a sampled incoming RF signal to the server that is determined by the first processor to include suspected interference. In an example, the second processor can execute program instructions to analyze the transmitted profile to extract characteristics of the sampled RF signal. Such characteristics can include a spectrum of frequencies within which a suspected interfering signal exists, an amplitude of a signal that includes suspected interference, a duration over which a suspected interfering signal exists, etc. In an example, a server may communicate with a machine learning program, which may involve use of a convolutional neural network, to execute program instructions to classify an interference characteristic. In an example, via classification of an interfering signal characteristic, a machine learning program can be trained to recognize and/or classify interfering signals from additional client ground stations of the wireless communications network. In an example, in response to a machine learning program encountering a previously unknown interference characteristic, the machine learning program can be trained, such as utilizing supervised learning, unsupervised learning, semi-supervised learning (e.g., utilizing a relatively small portion of labeled examples and a relatively large number of unlabeled examples), or another machine learning technique, to recognize and/or classify interference characteristics of signals received at other client ground stations.

A server (e.g., having a second processor) may additionally execute program instructions to mitigate interference, such as by requesting a modification to an RF spectrum (e.g., from a first RF spectrum to a second RF spectrum) utilized to transmit signals from, for example, an orbiting geosynchronous satellite to a client ground station, so as to avoid an interfering signal present in the first RF spectrum. In another example, a server can execute program instructions to mitigate interference by way of transmitting a request to an operator of an interfering satellite, such as an operator of a LEO satellite communications network, to discontinue transmitting signals while the LEO satellite is traversing between the geosynchronous satellite and the client ground station.

In an example, a system can include a first processor and a first memory coupled to the first processor and a second processor and a second memory coupled to the second processor the first memory can store instructions executable by the first processor, including instructions to transmit a sample of a first received signal that includes suspected interference responsive to a query from the second processor. The second memory of the system can store instructions executable by the second processor to extract a suspected interference characteristic from the sample and to generate a parameter for input to a machine learning application based on the extracted suspected interference characteristic, in which the input parameter includes a weight or a setting. The instructions executable by the second processor can additionally be to transmit a first request to a transmitter of the first received signal to modify a parameter of the transmitter responsive to the input parameter. Alternatively or in addition, a first processor can be configured by a server to transmit, on a recurring and/or scheduled basis, a sample of a first received signal spectrum that includes suspected interference.

In an example, the suspected interference characteristic can include a deviation in received signal power over a first RF spectrum of the first received signal relative to a linear approximation of the signal power of the first received signal over the first RF spectrum.

In an example, the transmitted first request can include a request to an orbiting satellite to discontinue transmitting the first received signal utilizing a first spectrum.

In an example, the transmitted first request can additionally include a request to initiate transmission of a second signal utilizing a second spectrum.

In an example, the instructions can additionally include instructions to generate a training input to the machine learning application, the training input including a square waveform or trapezoidal-shaped waveform modified via an addition of a selectable machine-generated noise signal.

In an example, a method can include obtaining a sample of a first received signal, extracting a suspected interference characteristic from the sample, generating a parameter for input to a machine learning application based on the extracted suspected interference characteristic, and transmitting a first request to a transmitter of the first received signal to modify a parameter of the transmitter responsive to the input parameter.

In an example, the suspected interference characteristic can include a deviation in received signal power over a first RF spectrum of the first received signal relative to a linear approximation of the signal power of the first received signal over the first RF spectrum.

In an example, the method can additionally include determining a curve fit representing the deviation in a power of the first received signal over the first spectrum.

In an example, the deviation in the received signal power can be determined based on a curve fit representative of a power of the first received signal over of the first RF spectrum exceeding a threshold with respect to the linear approximation.

In an example, the transmitted first request can include a request to discontinue transmitting the first received signal utilizing a first RF spectrum.

In an example, the transmitted first request can additionally include a request to an orbiting satellite to initiate transmission of a second RF signal utilizing a second RF spectrum.

In an example, the method can additionally include transmitting a second request to an operator of a communications system generating the suspected interference, the second request can include a request to discontinue a transmit operation.

In an example, a system can include a first processor, coupled to a first memory, to interact with a second processor coupled to a second memory. The first memory can store instructions executable by the first processor to transmit a sample of a first received signal that includes suspected interference responsive to a query from the second processor. The memory coupled to the second processor can include instructions to extract a suspected interference characteristic from the sample and to generate a parameter for input to a machine learning application based on the extracted suspected interference characteristic. The input parameter can include a weight or a setting. The second memory can include instructions to transmit a first request to a transmitter of the first received signal to modify a parameter of the transmitter responsive to the input parameter. In an example, input parameters can include model weights of a neural network learned in response to training of the neural network and/or other types of machine-learned settings.

Alternatively or in addition, the second memory can execute instructions to modify parameters that control a transmission from a transmitter, so as to mitigate suspected interference in transmissions to a client ground station.

The suspected interference characteristic can include a deviation in received signal power over a first RF spectrum of the first received signal relative to a linear approximation of the signal power of the first received signal over the first RF spectrum.

The deviation in the signal power of the first received signal can be determined at the first processor via a curve fit of a power of the first received signal over the first RF spectrum.

The deviation in the signal power of the first received signal can be determined at the first processor based on a curve fit representative of the first received signal power over the first RF spectrum exceeding a threshold with respect to the linear approximation.

In an example, extracting the suspected interference characteristic from the sample can include transmitting a request from the second processor to the first processor to supply signal power data.

In an example, the transmitted first request can additionally include a request to initiate transmission of a second signal utilizing a second spectrum.

In an example, the transmitted first request can additionally include a request to discontinue transmitting the first received signal utilizing a first RF spectrum.

In an example, the transmitted first request can include a request to an orbiting satellite to discontinue transmitting the first received signal utilizing a first spectrum.

### Exemplary System Operation

FIG. 1 is a diagram of an example network 100 that utilizes satellite 105 to communicate with client ground station 145. As indicated in FIG. 1, satellite 105 orbits Earth 140 within the communications range of client ground station 145. Satellite 105 can be positioned in a geosynchronous orbit that permits antenna 150 of client ground station 145 to be continuously oriented in the direction of satellite 105. In an example, antenna 150 can include any suitable antenna, such as an electronically scanned phased array of antennas, e.g., patch antennas, having a main beam that is capable of being repositioned in the direction of satellite 105, so as to maintain a wireless communications link between client ground station 145 and satellite 105. In another example, antenna 150 can include a parabolically-shaped antenna capable of being mechanically positioned towards satellite 105.

In the example communications network of FIG. 1, satellite 105 can transmit RF signals to client ground station 145 via any suitable modulation technique utilizing RF signal spectrum 115. Such modulation techniques can include a QAM technique (i.e., in which variations in amplitude and phase are utilized to modulate a carrier waveform), frequency-shift keying (i.e., in which variations in frequency are utilized to modulate a carrier waveform), phase-shift keying, (i.e., in which variations in phase are utilized to modulate a carrier waveform), or may utilize another suitable modulation technique. Satellite 105 can transmit data to client ground station 145 at any suitable data rate, such as 100 megabits per second, 200 megabits per second, 250 megabits per second, etc. In the example of FIG. 1, satellite 105 receives signals from, and transmits signals to, gateway 190, which directs operations of satellite 105. Accordingly, in an example, gateway 190 can direct satellite 105 to be repositioned, so as to maintain satellite 105 in a geosynchronous orbit, as well as to upload parameters that satellite 105 utilizes to communicate with client ground station 145. In an example that includes satellite 105 being a regenerative satellite having onboard processing and a modem, such parameters can include a modulation technique utilized to communicate with client ground station 145, an RF signal spectrum utilized to communicate with client ground station 145, a transmit power level, etc. In an example that includes satellite 105 being a transponder satellite without onboard processing or an onboard modem, such parameters can include a modulation technique utilized by gateway 190 to communicate with client ground station 145.

Client ground station 145 can include receiver 155, which forms a part of the electronic components of client ground station 145. Receiver 155 can include components to amplify signals received from satellite 105, components to down-convert a received signal, components to demodulate a received signal, and components to decode a received error control coded signal. Thus, an output signal from receiver 155 can include baseband voice or data signal transmitted from satellite 105. Signals received from satellite 105 can include content of any type, such as voice messages, text messages, multimedia files, commercial and/or business-related data, or any other content that can be uploaded to satellite 105 via gateway 190. Received down-converted baseband signals can be processed by first processor 160 coupled to memory 165. Thus, in an example, first processor 160 can include a multimedia processor capable of assembling a baseband video and/or audio stream for display utilizing a suitable display, such as a high-definition television display. In another example, first processor 160 can include a general-purpose computer processor capable of rendering Internet content from the World Wide Web.

In the example of FIG. 1, RF signals transmitted from satellite 105 to client ground station 145 may utilize signal spectrum 115 as shown in signal profile 110. The vertical axis of signal profile 110 represents transmitted (Xmit) RF power in decibels relative to one watt (dBW), and the horizontal axis represents the RF spectrum of a received signal. In an example, transmit signal spectrum 115 can include a signal spectrum of 100 megahertz, 200 megahertz, 250 megahertz, or any other suitable spectrum of radio frequencies. In an example, signal spectrum 115 can include a range of frequencies located in the Ka communications band having a carrier frequency of between 26.5 gigahertz and 40.0 gigahertz. However, in other examples, signal spectrum 115 can be located in different frequency bands, such as the Ku band having a carrier frequency of between 12 gigahertz and 18 gigahertz, or another frequency band that is suitable for providing a communications capability between satellite 105 and client ground station 145.

Signals received by client ground station 145 are shown in FIG. 1 represented by signal profile 170. Signal profile 170 can represent a memory array generated within a range of addresses of memory 165 via program instructions executed by first processor 160. The vertical axis of signal profile 170 represents received (Rcvd) RF power in decibels relative to one milliwatt (dBm), and the horizontal axis represents frequency. In the example of FIG. 1, an RF signal received from satellite 105 may exhibit marginal or negligible interference from, for example, microwave transmitter 130 and/or from non-client ground station 135. Accordingly, the received RF power depicted in signal profile 170 accords with signal profile 110, which represents the signal transmitted from satellite 105. Deviations between signal profiles 110 and 170 may be in response to, for example, variations in signal propagation characteristics of the atmosphere of the Earth 140, (e.g., atmospheric scattering, absorption, polarization, etc.).

In an example, microwave transmitter 130 can represent a microwave transmitter that at least occasionally operates within RF signal spectrum 115. In an example, microwave transmitter 130 and/or non-client ground station 135 can be spaced a suitable distance from antenna 150 of client ground station 145, so as to generate negligible interference received at client ground station 145. Accordingly, receiver 155 of client ground station 145 may receive relatively low or negligible interfering signal power (e.g., −75 dBm, −80 dBm, −90 dBm) from microwave transmitter 130 and/or from non-client ground station 135. Thus, RF signal spectrum 115 may exhibit or indicate interference that is within the capability of receiver 155 to down-convert, demodulate, and decode signals transmitted from satellite 105.

In an example, receiver 155 can utilize an error control code (e.g., a Reed Solomon convolutional error control code, a hamming code, etc.) to permit client ground station 145 to decode signals transmitted from satellite 105 in the presence of a relatively small or negligible amount (e.g., −75 dBm, −80 dBm, −90 dBm) of interfering signal power. In addition to utilizing an error control code, receiver 155 may also communicate with gateway 190, so as to inform gateway 190 of a degradation in signal quality, which may include an increase in bit error rate, an increase in a ratio of signal to interfering noise of a received signal, etc. In an example that includes satellite 105 being a regenerative satellite having onboard processing and a modem, responsive to receiving data from client ground station 145 indicating a degradation of signal quality, gateway 190 can request satellite 105 to utilize a modulation technique that can permit client ground station 145 to receive signals under degraded conditions. In an example that includes satellite 105 being a transponder satellite without onboard processing or a modem, gateway 190 can utilize a modulation technique that can permit client ground station 145 to receive signals under degraded conditions.

However, on occasion, microwave transmitter 130 and/or non-client ground station 135 may generate signals that interfere significantly with signals transmitted from satellite 105 as shown in received signal profile 180. Signal profile 180, in which the vertical axis represents received RF power and the horizontal axis represents the RF spectrum of a received signal, can be arranged utilizing an array of addresses of memory 165 via program instructions executed by first processor 160. In an example, such interference can include interfering signal power that is greater than, for example, −60 dBm, −70 dBm, −75 dBm, etc. Such interference may be the result of unpredictable atmospheric conditions, which can operate to unexpectedly channel signal energy from microwave transmitter 130 and/or non-client ground station 135 in the direction of antenna 150. Such interference can also be the result of reflections from conductive metallic structures positioned nearby microwave transmitter 130 and/or non-client ground station 135, which operate to redirect signal energy from microwave transmitter 130 and/or non-client ground station 135 in the direction of antenna 150. In another example, such interference can be the result of changes in the directivity of radiating antenna patterns of microwave transmitter 130 and/or non-client ground station 135.

In addition to receiving interference from microwave transmitter 130 and/or non-client ground station 135, antenna 150 may receive interference from LEO satellite 195, which may be operating in an exclusion arc located between antenna 150 and satellite 105. In this context, an “exclusion arc” means a portion of a path of travel of a LEO satellite within which a transmitted signal from the LEO satellite interferes with a transmitted signal from a geosynchronous satellite. Accordingly, in the example of FIG. 1, LEO satellite 195 may be obligated to refrain from transmitting RF signals while LEO satellite 195 is positioned within the beamwidth of the main lobe of antenna 150 as antenna 150 is directed toward satellite 105. In an example, LEO satellite 195 may be capable of erroneously transmitting while operating within exclusion arc 125.

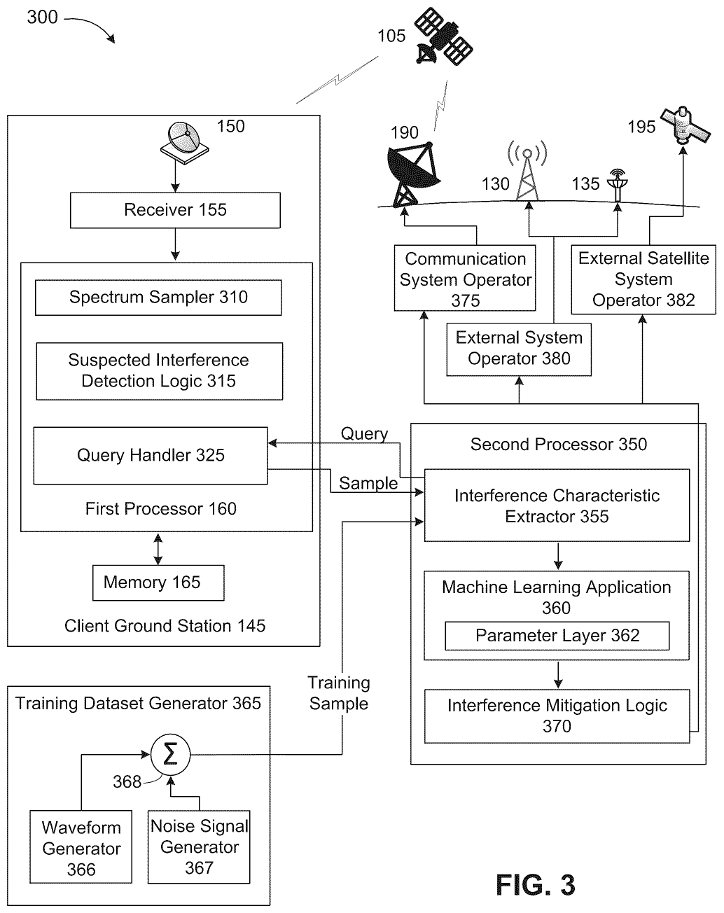

Thus, as shown in received signal profile 180, a received RF spectrum may exhibit significant variations in received signal power responsive to signals from an interfering source. For example, as represented by signal profile 180, receiver 155 may receive signals generated by an interfering noise source that are comparable in power to signals received from satellite 105. In an example, responsive to such an increase in interference from microwave transmitter 130 and/or non-client ground station 135, client ground station 145 may be unable to decode signals transmitted from satellite 105. Thus, for example, although satellite 105 and client ground station 145 may employ an error control code as well as noise-resistant modulation coding schemes, interference from microwave transmitter 130 and/or non-client ground station 135 may be beyond the capability of receiver 155 to maintain a data communications link between client ground station 145 and satellite 105. Accordingly, as further described in reference to FIG. 3, client ground station 145 can cooperate with a server-based interference processor (e.g., second processor 350) to execute program instructions to sample a received RF signal over a spectrum and to determine whether suspected interference is present. In an example, responsive to a query from the server-based interference processor (e.g., processor 350), first processor 160 can execute program instructions to transmit a sample of a received RF signal spectrum to second processor 350. After receipt of the sample of the received RF signal spectrum, second processor 350 can execute program instructions to extract characteristics from the sampled RF signal spectrum and to detect and possibly mitigate such suspected interference.

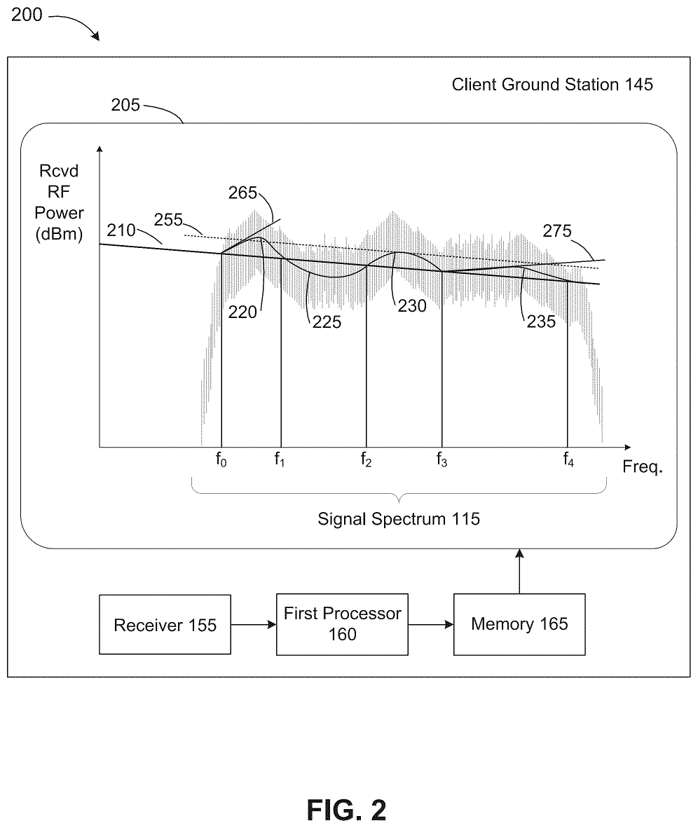

FIG. 2 is a diagram 200 showing a profile of a received RF signal combined with an interfering signal received at client ground station 145. In received signal profile 205, the vertical axis represents received RF power (in dBm), and the horizontal axis represents the frequency spectrum of the signal received at client ground station 145. Received signal profile 205 can represent a memory array generated within a range of addresses of memory 165 in response to program instructions executed by first processor 160. In an example, frequency spectrum f₀-f₄ can include a frequency bandwidth of 100 megahertz, 200 megahertz, 250 megahertz, etc. As seen in FIG. 2, a relatively high degree of interference (e.g., +5 dBm, +10 dBm, +15 dBm, etc.) results in sharp increases and/or substantial fluctuations in the power of the received RF signal as a result of the combined power of the received signal and the suspected interfering signal. In addition, such fluctuations in power vary in amplitude over the frequency spectrum f₀-f₄. As described in reference to FIG. 1, interference may be the result of antenna 150 receiving signals from microwave transmitter 130 and/or non-client ground station 135. Such reflections may be the result of changing atmospheric signal propagation conditions, which can operate to unexpectedly direct signal energy from microwave transmitter 130 and/or non-client ground station 135 in the direction of antenna 150. Such interference can also be the result of reflections from conductive metallic structures positioned nearby microwave transmitter 130 and/or non-client ground station 135, which operate to redirect signal energy from microwave transmitter 130 and/or non-client ground station 135 in the direction of antenna 150. In other instances, such interference can be the result of degradations in the directivity of radiating antenna patterns of microwave transmitter 130 and/or non-client ground station 135. Degradations in the directivity of a radiating antenna pattern can result from a loss of phase and/or amplitude control over components of a radiating element of microwave transmitter 130 and/or non-client ground station 135.

In an example, microwave transmitter 130 and/or non-client ground station 135 may generate an interfering signal over an RF spectrum of frequencies that is smaller than an RF spectrum of frequencies utilized to transmit a signal from satellite 105 to client ground station 145. Thus, as shown in FIG. 2, an interfering signal may be suspected to exist between frequencies f₀ and f₁ and between frequencies f₂ and f₃. Thus, in an example in which frequency spectrum f₀-f₄ represents a frequency range of 100 megahertz, a frequency range of f₀-f₁ can represent a frequency spectrum or range of, for example, 10 megahertz, 20 megahertz, 25 megahertz, etc. In addition, an interfering signal may be present for a brief period, such as a period of 30 seconds, one minute, five minutes, etc. Such interference may be a result of a chain of LEO satellites in the same or in a similar orbital plane successively passing between a GEO satellite and a ground station in which a transmitter of each LEO satellite remains active, thus leading to interference received at client ground station 145. In an example, first processor 160 can intermittently sample signals from receiver 155, so as to determine whether an interfering signal is present in a signal from antenna 150 (of FIG. 1). In an example, first processor 160 can sample a signal over an RF spectrum at one-second intervals, five-second intervals, 30-second intervals, etc. In an example, first processor 160 can sample a signal over an RF spectrum in response to first processor 160 detecting an increase in bit error rate of a received signal, an increase in errors detected/corrected by an error control code, a detected increase in power of a received signal, or in response to another indication of a degradation in the quality of an RF signal received from satellite 105.

First processor 160 can execute program instructions to determine whether suspected interference is exhibited in a received signal. In the example of FIG. 2, first processor 160 can execute program instructions to sample a spectrum of a first received RF signal from satellite 105 and execute program instructions to determine a linear approximation (e.g., linear approximation 210) of the first received RF signal. In this context, a “linear approximation” means a process of estimating the value of the power level of a signal over a received RF spectrum utilizing a linear function. Accordingly, in an example, linear approximation 210 includes an unbending or non-curved line that extends from, for example, a first frequency (e.g., f₀) to a second frequency (e.g., f₄). In the example of FIG. 2, linear approximation 210 accords with the general expression P(f)=af+b, in which “P(f)” represents the power of a received RF signal, “f” represents the frequency of the received signal, “a” represents to a negative or positive slope of linear approximation 210, and “b” represents a point on the vertical axis (Rcvd RF Power of signal profile 205) intercepted by linear approximation 210.

In an example, as an indication of suspected interference, first processor 160 may determine that linear approximation 210 of the spectrum of the first received signal from satellite 105 includes a nonzero (or non-negligible) slope. In an example, any positive or negative slope of a linear approximation of a spectrum of a received signal may indicate a presence of interference over an RF spectrum (e.g., between f₀-f₁) of a larger received RF signal spectrum (e.g., f₀-f₄). Accordingly, as shown in FIG. 2, first processor 160 may determine, as a result of the negative slope exhibited by linear approximation 210, that suspected interference is present over spectrum f₀-f₁ of a first received signal from satellite 105. In other examples, an amount of a determined negative slope of linear approximation 210, such as a negative slope of less than, for example, −0.75, −1.0, −1.25, etc., may provide a stronger indication of suspected interference than a greater negative slope, such as a slope greater than −0.75, −0.65, −0.5, etc. In another example, first processor 160 may determine, as a result of a positive slope exhibited by linear approximation 210, that suspected interference is present over spectrum f₃-f₄ of a larger signal spectrum (e.g., f₀-f₄) of a first received signal from satellite 105. In an example, an amount of a positive slope, such as a positive slope greater than, for example, 0.75, 1.0, 1.25, etc., may provide a stronger indication of the presence of interference over RF spectrum f₃-f₄ of received RF signal spectrum f₀-f₄ than a lesser positive slope, such as a positive slope of less than 0.75, 0.65, 0.5, etc.

First processor 160 can additionally include program instructions to execute a curve fitting technique to approximate the received power over the RF spectrum of a signal from satellite 105. A curve fit to approximate the received power over an RF spectrum can be utilized to determine that suspected interference is present in a received signal. In this context, a “curve fit” means a technique to approximate a profile of the received power over an RF spectrum. Thus, for example, a curve fit may include a global polynomial approximation, a piecewise polynomial approximation, a piecewise cubic spline interpolation, a piecewise quintic spline approximation, or another approximation technique that operates to fit a curve that approximates at least a portion of the spectrum of a received signal with a bending or curved line. Thus, in the example of FIG. 2, first processor 160 can execute program instructions to determine a curve fit that approximates a signal sample from an RF spectrum. Accordingly, as shown in FIG. 2, curve fit 220 can approximate signals in frequency spectrum f₀-f₁. As further shown in FIG. 2, curve fit 225 can approximate signals in frequency spectrum f₁-f₂. As further shown in FIG. 2, curve fit 230 can approximate signals in frequency spectrum f₂-f₃. As further shown in FIG. 2, curve fit 235 can approximate signals in frequency spectrum f₃-f₄.

In the example of FIG. 2, first processor 160 can execute program instructions to determine whether a curve fit exceeds a linear approximation of a received signal over a frequency spectrum. In an example, a curve fit exceeding a linear approximation of a received signal spectrum can provide an indication that suspected interference is present in a received signal. For example, as shown in FIG. 2, curve fit 220 and curve fit 230 exceed linear approximation 210 over frequency spectrum f₀-f₁ and over frequency spectrum f₂-f₃ (respectively), which may provide an indication that suspected interference is present in a received signal. In an example, curve fit 220 is indicated as exceeding threshold 255, which may provide an additional indication of suspected interference in a received signal from satellite 105.

In an example, a curve fit over a first frequency spectrum being less than a linear approximation computed over a second frequency spectrum may represent an absence of suspected interference. For example, as shown in FIG. 2, curve fit 225 over frequency spectrum f₁-f₂ is shown as being less than linear approximation 210 over the frequency spectrum f₀-f₄. In such an example, program instructions executed by first processor 160 can determine an absence of suspected interference in frequency spectrum f₁-f₂.

First processor 160 can execute program instructions to analyze a curve fit to determine a slope at a point of the curve. In an example, a slope determined at a point on a curve fit can provide an indication of suspected interference in a received signal. Thus, for example, first processor 160 can execute program instructions to compute a slope of a portion of curve fit 220, so as to determine slope 265. In another example, first processor 160 can execute program instructions to compute a slope at a point on curve fit 235, so as to determine slope 275. In some examples, an amount of a determined slope of a curve fit, such as a positive slope greater than, for example, 0.75, 1.0, 1.25, etc., may provide a stronger indication of suspected interference than a lesser positive slope, such as a positive slope of less than 0.75, 0.65, 0.5, etc. In the example of FIG. 2, slope 265, which includes a slope of approximately 1.0, may provide a stronger indication of suspected interference than slope 275, which includes a slope of approximately 0.25. Accordingly, first processor 160 can execute program instructions that may indicate a higher likelihood of interference over frequency spectrum f₀-f₁ than over frequency spectrum f₃-f₄.

In an example, as described in greater detail in reference to FIG. 3, first processor 160 of client ground station 145 can respond to queries from second processor 350 to transmit samples of RF signal spectrum 115 for analysis by second processor 350. In an example, analysis of a received RF spectrum can confirm whether suspected interference is actually exhibited in the received spectrum. In an example, second processor 350 can utilize a machine learning application (e.g., machine learning application 360) to determine whether suspected interference is actually exhibited in a received frequency spectrum. As is further described in reference to FIG. 3, second processor 350 can generate a parameter for input to machine learning application 360 during a process of training machine learning application 360 to recognize future instances of suspected interference in a received RF signal spectrum sampled at the client ground station 145 and/or sampled at additional receiving client ground stations communicating with satellite 105.

FIG. 3 is a diagram 300 showing client ground station 145 communicating with second processor 350 to detect interference in a communications network. As shown in FIG. 3, first processor 160 of client ground station 145 can execute instructions to implement spectrum sampler 310, which can operate to sample signals received over a first RF spectrum. Samples of received signals, which can be sampled intermittently during operation of client ground station 145, can be stored in memory 165. First processor 160 of client ground station 145 can execute additional instructions to implement suspected interference detection logic 315, which can operate to generate linear approximation 210 (see FIG. 2) to determine whether suspected interference is present over a received RF spectrum. First processor 160 of client ground station 145 can execute additional instructions to implement query handler 325, which responds to a query from second processor 350 and/or to recurrently schedule reporting at hourly, daily, or another interval to supply a sample of a first received signal, sampled over received RF signal spectrum 115, that includes suspected interference.

Second processor 350 can execute instructions to implement interference characteristic extractor 355, which can operate to extract suspected interference characteristics from samples of an RF spectrum of a signal received at client ground station 145. In an example, interference characteristic extractor 355 can extract the slope of linear approximation 210. In another example, interference characteristic extractor 355 can extract the slope of a curve fit (e.g., slope 265, slope 275, etc.). In another example, interference characteristic extractor 355 can determine whether a curve fit exceeds threshold 255. In response to a determination that a curve fit exceeds threshold 255, interference characteristic extractor 355 can determine the extent by which a curve fit exceeds threshold 255 (e.g., by one dBm, by three dBm, by five dBm, etc.) and/or a frequency spectrum (e.g., between f₀-f₁) within which such excess occurs.

In an example, interference characteristic extractor 355 can interact with machine learning application 360 to determine whether extracted characteristics of a received RF spectrum accord with or are consistent with a machine-learned model of an RF spectrum that exhibits an interfering signal. In an example, machine learning application 360 can determine whether received signal profile 205 (see FIG. 2) has been encountered in a previously obtained sample of a received RF spectrum. Thus, for example, machine learning application 360 can determine that the slope of linear approximation 210 accords or is consistent with a model of an interfering signal obtained from a previous sample of a received RF spectrum from client ground station 145 or another client ground station proximate with microwave transmitter 130 and/or non-client ground station 135. In another example, machine learning application 360 can determine that curve fit 220 of received signal profile 205 accords or is consistent with a model of an interfering signal obtained from a previous sample of a received frequency spectrum from client ground station 145 or another client ground station proximate with microwave transmitter 130 and/or non-client ground station 135. In another example, machine learning application 360 may determine that curve fit 235 of received signal profile 205 does not accord with (or is inconsistent with) a model of an interfering signal obtained from a previous sample of a received RF spectrum sampled by client ground station 145 or by another client ground station.

In an example, machine learning application 360 includes a neural network, such as a convolutional neural network. In this context, a convolutional neural network means a feed-forward artificial neural network with at least three layers (i.e., an input layer, an output layer, and at least hidden layer). In an example, the input layer operates to receive as input a characteristic of a received RF signal spectrum from interference characteristic extractor 355. Such characteristics can include a slope of linear approximation 210, whether curve fit 220) exceeds threshold 255, an extent by which curve fit exceeds threshold 255, slope 265 or 275 of a curve fit, a frequency spectrum, such as f₀-f₁, within which such excess occurs, etc. Such characteristics can be formatted by the input layer to include parameters, i.e., data values, such as weights or settings, and input to parameter layer 362. In this context a “weight” or a “setting” means a parameter within a machine learning application that at least partly controls or governs the transformation or output of data from a neural network layer by performing an operation, e.g., addition, multiplication, convolution or another function, to provide data, e.g., at an output layer that can be observed by a human and/or by second processor 350.

In an example, responsive to successive inputs of interference characteristics from interference characteristic extractor 355, parameter layer 362 can be trained to interact with interference characteristic extractor 355 to recognize present and/or future instances of interference in a received frequency spectrum from client ground station 145 or another client ground station. Machine learning application 360 can be trained utilizing characteristics of RF signal spectra exhibiting interference from interference characteristic extractor 355. Alternatively, or in addition, machine learning application 360 can be trained utilizing characteristics of RF signal spectra exhibiting interference and/or utilizing training dataset generator 365 can include processing interference characteristics hundreds or thousands of times. An output from an output layer of machine learning application 360 can be analyzed utilizing supervised learning, unsupervised learning, semi-supervised learning, reinforced learning, etc., to determine whether machine learning application 360 can accurately detect interfering signals in a received RF signal spectrum. Outputs from an output layer of machine learning application 360 can be utilized to compute a loss function that represents an ability of the machine learning application to accurately predict an expected output. The loss function can be back propagated through parameter layer 362, altering the weights or settings stored at parameter layer 362 to minimize the loss function. Responsive to the loss function being minimized or reduced to a predetermined level, machine learning application 360 may be considered to be trained, and the current weights can be stored within parameter layer 362.

In an example, training dataset generator 365 includes waveform generator 366 and noise signal generator 367. In the example of FIG. 3, waveform generator 366 can include a generator to generate a square-shaped waveform, a trapezoidal-shaped waveform, or a waveform of another shape that represents an RF spectrum received RF signal. Generated waveforms can include waveforms representing received RF signal spectra of any received RF power (e.g., −60 dBm, −70 dBm, −80 dBm, etc.) over any frequency spectrum, such as a frequency spectrum of 100 megahertz, 200 megahertz, 250 megahertz, 500 megahertz, etc. In an example, waveform generator 366 can generate a trapezoidal-shaped waveform similar to transmit signal spectrum 115 of FIG. 1.

Noise signal generator 367 of training dataset generator 365 is capable of providing a machine-generated noise signal to represent suspected interference over a received RF spectrum. In an example, noise signal generator 367 can generate a selectable noise signal that represents an interfering signal, such as interfering signals from microwave transmitter 130, non-client ground station 135, LEO satellite 195, or another interfering signal. Signals from waveform generator 366 and noise signal generator 367 can be combined or aggregated via combiner 368, which provides a signal that represents, for example, received signal profile 205 or another received signal profile that is suspected of including an interfering signal.

In the example of FIG. 3, training dataset generator 365 can provide training samples representing received and interfering signals over an RF spectrum, so as to train parameter layer 362 of machine learning application 360. Accordingly, during training operations, training dataset generator 365 can generate numerous square-shaped or trapezoidal-shaped waveforms, along with varying noise signals over varying frequency spectra, so as to provide machine learning application 360 with examples of received signals modified with interfering signals. In an example, output signals from training dataset generator 365 can be input to interference characteristic extractor 355, which can determine characteristics of the training sample. In an example, a training operation can be conducted in a supervised manner, in which, for example, a human operator can determine whether a generated signal over a frequency spectrum accords or is consistent with a received signal modified with an interfering signal. In another example, a training operation can be conducted in an unsupervised manner, in which, for example, an output signal from machine learning application 360 is communicated to training dataset generator 365. In such an example, training dataset generator 365 can communicate directly with machine learning application 360 to inform machine learning application 360 whether a generated frequency spectrum actually exhibits (or does not exhibit) an interfering signal.

Second processor 350 can also execute program instructions to implement interference mitigation logic 370. In an example, interference mitigation logic 370 can operate to mitigate interference exhibited in a received RF signal spectrum. Accordingly, in an example, in response to machine learning application 360 determining that interference from microwave transmitter 130 and/or non-client ground station 135 is operating in a frequency spectrum assigned to satellite 105, interference mitigation logic 370 can communicate with external system operator 380. Such communication can include a request to external system operator 380 to discontinue interfering transmissions. In another example, interference mitigation logic 370 may determine that a suitable strategy for mitigating interference may be to bypass or avoid a frequency spectrum subject to interfering signals. In such an example, interference mitigation logic 370 may communicate with client gateway 190, via communication by system operator 375, to request that a communications channel between satellite 105 and client ground station 145 be modified from a first frequency spectrum to a second frequency spectrum.

In another example, in response to machine learning application 360 determining that an interfering signal in a received frequency spectrum emanates from LEO satellite 195, interference mitigation logic 370 can transmit a request to external satellite system operator 382 to discontinue transmit operations while LEO satellite 195 is orbiting within exclusion arc 125 (of FIG. 1). Such interfering transmit operations can occur in response to degradations in an ability of LEO satellite 195 to compute its position, degradations in transmit amplifier power control, etc.

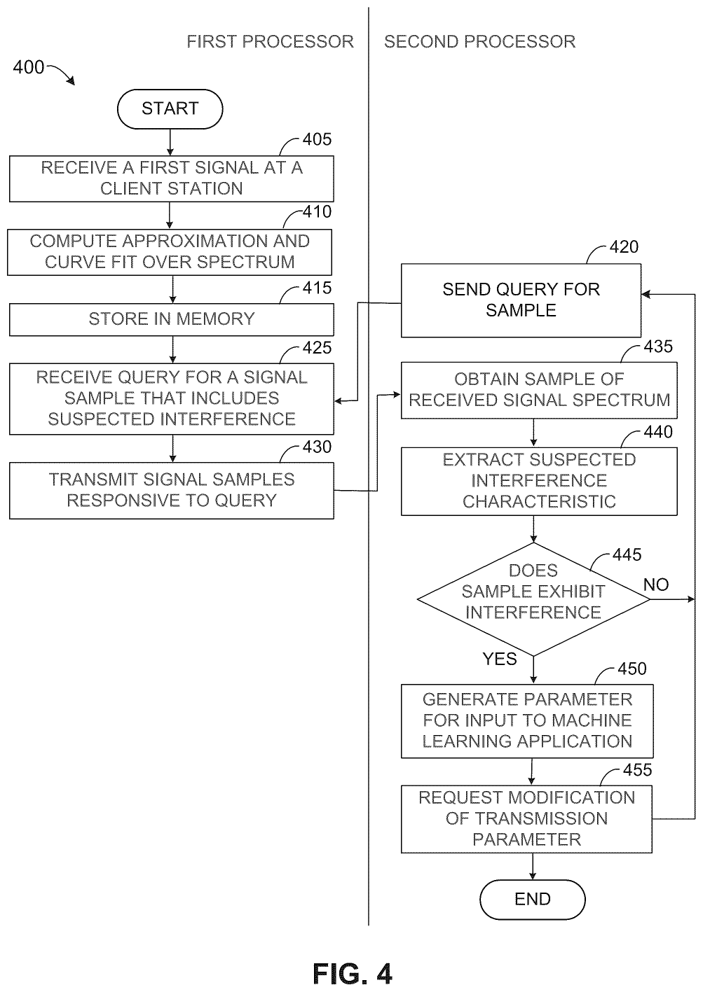

FIG. 4 is a flow diagram for a process 400 for interference detection and mitigation in a communications network. In an example, interference detection in a communications network can result in a capability for a client ground station (e.g., client ground station 145) to determine instances of suspected interference in a received signal from a geosynchronous satellite (e.g., satellite 105). Instances of suspected interference can be determined via a first processor (e.g., first processor 160) of a client ground station (e.g., client ground station 145) sampling a received RF signal spectrum. The first processor (e.g., first processor 160) can execute program instructions to compute a linear approximation (e.g., linear approximation 210), to compute a slope of a linear approximation, and to compute one or more curve fits of a received RF spectrum, which may be transmitted to a second processor (e.g., second processor 350). The second processor (e.g., second processor 350) can execute program instructions to extract characteristics of suspected interference in a received signal. Extracted characteristics can be utilized to train a machine learning application (e.g., machine learning application 360), so as to permit the machine learning application to recognize future instances of signals exhibiting interference from the client ground station (e.g., client ground station 145). The second processor (e.g., second processor 350) can additionally execute program instructions to mitigate interference by transitioning signal transmission from a geosynchronous satellite (e.g., satellite 105) from a first RF spectrum to a second RF spectrum, by requesting interfering transmitters (e.g., microwave transmitter 130, non-client ground station 135, LEO satellite 195), to discontinue transmitting utilizing a first RF spectrum.

Process 400 begins at block 405, which includes client ground station 145 receiving a first signal transmitted from satellite 105 utilizing an RF signal spectrum 115. Block 405 can additionally include receiving interfering signals, such as signals from microwave transmitter 130, non-client ground station 135, LEO satellite 195, etc.

Process 400 continues at block 410, which includes first processor 160 of client ground station 145 executing program instructions to compute linear approximation 210 of a received RF signal spectrum. Block 405 can additionally include first processor 160 executing instructions to compute one or more curve fits, such as 220, 225, 230, and 235 of FIG. 2 within the RF spectrum. Block 405 can further include determining whether one or more curve fits exceed predetermined threshold 255.

Process 400 continues at block 415, which can include storing a sample, such as received signal profile 205 in memory 165. Block 415 can additionally include storing the linear approximation and the curve fit of received RF power over the signal spectrum in memory 165.

Process 400 continues at block 420, which can include second processor 350 sending a query for a stored sample of a received RF signal spectrum to first processor 160. Second processor 350 may send queries to first processor 160 at intervals (e.g., every one minute, every five minutes, every 30 minutes, etc.), so as to monitor the signal environment at client ground station 145. Second processor 350 may send queries to additional processors of ground stations of the communications network similar to client ground station 145, so as to monitor the signal environment of other ground stations of the communications network.

Process 400 continues at block 425, which can include first processor 160 receiving a query from second processor 350 that requests a signal sample that includes suspected interference.

Process 400 continues at block 430, which can include first processor 160 transmitting signal samples to second processor 350. Block 430 can additionally include transmitting linear approximation 210, such as at block 430, transmitting a slope of linear approximation 210, and transmitting one or more curve fits (220, 225, 230, 235) of received RF signal spectrum 115.

Process 400 continues at block 435, which includes second processor 350 obtaining a sample of a spectrum of a signal received at client ground station 145. Block 435 can additionally include obtaining a linear approximation, 210 obtaining a slope of linear approximation 210, and/or obtaining one or more curve fits (220, 225, 230, 235) of received RF signal spectrum 115.

Process 400 continues at block 440, which includes second processor 350 extracting characteristics of suspected interference. Characteristics of suspected interference can include determining whether a curve fit exceeds threshold 255, determining the extent by which a curve fit exceeds threshold 255 (e.g., one dBm, three dBm, five dBm, etc.) and/or a frequency spectrum (e.g., between f₀-f₁) within which such excess occurs.

Process 400 continues at block 445, which includes second processor 350 interacting with machine learning application 360 to determine whether suspected interference is actually exhibited in a received RF spectrum. Block 445 can additionally include generating a parameter for input to machine learning application 360 during a process of training machine learning application 360 to recognize future instances of suspected interference in a received RF spectrum sampled at the client ground station 145 and/or at additional receiving client ground stations communicating with satellite 105.

Process 400 continues at block 450, which includes second processor 350 generating a parameter for input to machine learning application 360. Block 450 can include second processor 350 generating a parameter for input to a machine learning application based on an extracted suspected interference characteristic, in which the input parameter includes a weight or a setting, i.e., a data value, stored at parameter layer 362 of machine learning application 360. Block 450 can additionally include training dataset generating 365 generating a waveform (e.g., a square-shaped or trapezoidal-shaped waveform) along with a noise signal over an RF spectrum to provide machine learning application 360 with an example of a signal with an interfering or a non-interfering signal.

Process 400 continues at block 455, which includes second processor 350 mitigating interference, such as by requesting satellite 105 to modify a transmission parameter, such as an RF signal spectrum, a modulation coding scheme, etc., utilized to communicate with client ground station 145. Alternatively or in addition, block 455 can include requesting an interfering noise source, such as microwave transmitter 130 or non-client ground station 135 to discontinue transmit operations in a frequency spectrum shared with RF signal spectrum 115. Alternatively or in addition, block 455 can include transmitting a request to an operator of LEO satellite 195 to discontinue transmit operations in exclusion arc 125 of the orbit of LEO satellite 195.

After block 455, process 400 ends.

Computers or processors utilized by, for example, first processor 160 and second processor 350 may include one or more processors coupled to a memory. A computer memory can include one or more forms of computer readable media, and stores instructions executable by a processor for performing various operations, including as disclosed herein. For example, the computer can be a generic computer with a processor and memory as described above and/or a controller, or the like for a specific function or set of functions, and/or a dedicated electronic circuit including an ASIC that is manufactured for a particular operation, e.g., an ASIC for processing radio data. In another example, computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer. To implement machine learning computations, a graphics processing unit (GPU) may be utilized. A GPU can include a specialized processing capability, such as a capability to perform enhanced mathematical computation.

As used herein, a computer memory can be of any suitable type, e.g., EEPROM, EPROM, ROM, Flash, hard disk drives, solid state drives, servers, or any volatile or non-volatile media. The memory can store data. The memory can be a separate device from the computer, and the computer can retrieve information stored in the memory. Alternatively, or additionally, the memory can be part of the computer, i.e., as a memory of the computer or firmware of a programmable chip.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
a processor and a memory, the memory storing instructions executable by the processor, including instructions to:
obtain a sample of a first received signal;
extract a suspected interference characteristic from the sample;
generate a parameter for input to a layer of a machine learning application based on the extracted suspected interference characteristic, the input parameter including a weight or a setting; and
transmit a first request to a transmitter of the first received signal to modify a parameter of the transmitter responsive to the input parameter.

2. The system of claim 1, wherein the suspected interference characteristic includes a deviation in received signal power over a first radio frequency (RF) spectrum of the first received signal relative to a linear approximation of the signal power of the first received signal over the first RF spectrum.

3. The system of claim 1, wherein the transmitted first request includes a request to an orbiting satellite to discontinue transmitting the first received signal utilizing a first spectrum.

4. The system of claim 3, wherein the transmitted first request additionally comprises a request to initiate transmission of a second signal utilizing a second spectrum.

5. The system of claim 1, wherein the instructions additionally include instructions to generate a training input to the machine learning application, the training input including a square waveform or trapezoidal-shaped waveform modified via an addition of a selectable machine-generated noise signal.

6. A method, comprising:
obtaining a sample of a first received signal;
extracting a suspected interference characteristic from the sample;
generating a parameter for input to a layer of a machine learning application based on the extracted suspected interference characteristic; and
transmitting a first request to a transmitter of the first received signal to modify a parameter of the transmitter responsive to the input parameter.

7. The method of claim 6, wherein the suspected interference characteristic includes a deviation in received signal power over a first radio frequency (RF) spectrum of the first received signal relative to a linear approximation of the signal power of the first received signal over the first RF spectrum.

8. The method of claim 7, further comprising:
determining a curve fit representing the deviation in a power of the first received signal over the first spectrum.

9. The method of claim 7, wherein the deviation in the received signal power is determined based on a curve fit representative of a power of the first received signal over of the first RF spectrum exceeding a threshold with respect to the linear approximation.

10. The method of claim 6, wherein the transmitted first request includes a request to discontinue transmitting the first received signal utilizing a first RF spectrum.

11. The method of claim 10, wherein the transmitted first request additionally comprises a request to an orbiting satellite to initiate transmission of a second RF signal utilizing a second RF spectrum.

12. The method of claim 6, further comprising:
transmitting a second request to an operator of a communications system generating the suspected interference, the second request to include a request to discontinue a transmit operation.

13. A system, comprising:
a first processor and a first memory coupled to the first processor; and a second processor and a second memory coupled to the second processor;
the first memory storing instructions executable by the first processor, including instructions to:
transmit a sample of a first received signal that includes suspected interference responsive to a query from the second processor; and
the second memory storing instructions executable by the second processor to:
extract a suspected interference characteristic from the sample;
generate a parameter for input to a layer of a machine learning application based on the extracted suspected interference characteristic, the input parameter to include a weight or a setting; and
transmit a first request to a transmitter of the first received signal to modify a parameter of the transmitter responsive to the input parameter.

14. The system of claim 13, wherein the suspected interference characteristic includes a deviation in received signal power over a first radio frequency (RF) spectrum of the first received signal relative to a linear approximation of the signal power of the first received signal over the first RF spectrum.

15. The system of claim 14, wherein the deviation in the signal power of the first received signal is determined at the first processor via a curve fit of a power of the first received signal over the first RF spectrum.

16. The system of claim 14, wherein the deviation in the signal power of the first received signal is determined at the first processor based on a curve fit representative of the first received signal power over the first RF spectrum exceeding a threshold with respect to the linear approximation.

17. The system of claim 13, wherein extracting the suspected interference characteristic from the sample includes transmitting a request from the second processor to the first processor to supply signal power data.

18. The system of claim 13, wherein the transmitted first request additionally comprises a request to initiate transmission of a second signal utilizing a second spectrum.

19. The system of claim 13, wherein the transmitted first request additionally comprises a request to discontinue transmitting the first received signal utilizing a first RF spectrum.

20. The system of claim 13, wherein the transmitted first request includes a request to an orbiting satellite to discontinue transmitting the first received signal utilizing a first spectrum.
